(19) United States
(12) Patent Application Publication
(10) Pub. No.: US 2025/0308518 A1
(43) Pub. Date: Oct. 2, 2025

(54) METHOD FOR SPEECH RECOGNIZING IN MULTI-SPEAKER ENVIRONMENT AND SYSTEM THEREOF

(71) Applicant: INVENTIS CO., LTD., Seoul (KR)

(72) Inventor: Hoontack OH, Seongnam-si (KR)

(73) Assignee: INVENTIS CO., LTD., Seoul (KR)

(21) Appl. No.: 18/619,480

(22) Filed: Mar. 28, 2024

(51) Int. Cl. G10L 15/20; G01C 21/36; G10L 13/08; G10L 15/18; G10L 15/22; G10L 15/26

(52) U.S. Cl. CPC G10L 15/20; G01C 21/3608; G01C 21/3629; G10L 13/08; G10L 15/1815; G10L 15/22; G10L 15/26

(57) ABSTRACT

A speech recognizing method in a multi-speaker environment is disclosed. The method may comprise determining a relation type between first and second speakers by analyzing a first conversation voice of the speakers inputted through a microphone of a computing system; receiving a first conversation voice input of the first or second speaker, and determining a speaker role in the relation type by semantic analysis of the first conversation voice; and extracting a voice feature of the first conversation voice and determining a voice feature of the speaker; receiving a second conversation voice input of the first or second speaker, and determining a speaker role of the second conversation voice in the relation type by using the voice feature extracted from the second conversation voice; and determining a personalized service corresponding to the second conversation voice by using the speaker role of the second conversation voice in the relation type.

### TECHNICAL FIELD

Disclosed are a method for speech recognizing in multi-speaker environment and a system using thereof. More specifically, the present disclosure relates to a method for identifying a relation between a plurality of speakers and providing a service, and a system in which the method is applied.

### BACKGROUND

Hereinafter, a conventional method of executing commands through speech recognition will be described using an example of a navigation system in a mobility device.

The method of executing commands through speech recognition performed by a conventional navigation system uses a method of processing speech commands received from a driver and speech commands received from a passenger with the same operation.

In the above case, for embodiment, when a passenger utters a speech command to the navigation system to play music, the conventional navigation system simply plays the same music which the driver usually plays, which is not in accordance with the passenger's music preference.

On the other hand, conventional navigation systems are designed to perform an operation corresponding to a speech command whenever the systems receive an utterance corresponding to the speech command, regardless of whether the speech command is uttered by the driver or a passenger.

In the above case, for embodiment, when a passenger utters a speech command associated with the driving of the mobility device, the driver may experience an unexpected change in the driving environment and cause a risk.

Accordingly, there is a need for a method of automatically identifying a relation between a driver and a passenger, performing an operation in response to a customized speech command according to the information of the relation between the driver and the passenger, and restricting an authority of the passenger to a part of speech commands, which has not been provided.

### DETAILED DESCRIPTION

### Object

A technical problem to be achieved through some embodiments of the present disclosure is to provide a method of automatically setting a relation type between a driver and a passenger based on the content of a conversation between the driver and the passenger.

Another technical problem to be achieved through some embodiments of the present disclosure is to provide a method of performing the same speech command uttered by each of the driver and the passenger with a different operation based on the information about the relation between the driver and the passenger.

Another technical problem to be achieved through some embodiments of the present disclosure is to provide a method of limiting the authority to perform some speech commands of a passenger based on information about the relation between the driver and the passenger.

Another technical problem to be achieved through some embodiments of the present disclosure is to provide a method of outputting a query for a parameter necessary for an operation corresponding to a speech command which is missing in a speech command uttered by a driver.

The technical problems of the present disclosure are not limited to the technical problems mentioned above, and other technical problems not mentioned would be clearly understood by those skilled in the art from the following description.

### Means

A speech recognizing method in a multi-speaker environment according to one embodiment of the present disclosure to solve the above technical problems, comprises: analyzing a first conversation voice of a first speaker and a second speaker input through a microphone included in a computing system to determine a relation type between the first speaker and the second speaker; receiving input of a first conversation voice uttered by the first speaker or the second speaker, and determining a role of the speaker in the relation type through semantic analysis of the input conversation voice; extracting a voice feature of the input first conversation voice, and determining the extracted voice feature as a voice feature of a speaker of the determined role; receiving the input of a second conversation voice uttered by the first speaker or the second speaker, and determining the role of the speaker of the second conversation voice in the relation type using the voice feature extracted from the second conversation voice; and determining a personalized service corresponding to the second conversation voice, using the role of the speaker of the second conversation voice in the relation type.

In some embodiments, the method may further comprise: displaying on a screen a script obtained as a result of Speak-To-Text (STT) processing of an utterance by the first speaker or the second speaker; receiving a selection input for a third conversation voice uttered by the second speaker included in the script; and determining a role of the second speaker within a relation type based on the information entered for the third conversation voice.

In some embodiments, the method may further comprise: identifying that an utterance of the first speaker or an utterance of the second speaker has not been received for a reference time or more; inputting the script into a first artificial neural network and outputting a text to speech (TTS) voice generated by the first artificial neural network, based on the output of the first artificial neural network.

In some embodiments, the method may further comprise: identifying a first speech command corresponding to an operation associated with a seat in a fourth conversation voice uttered by the first speaker or the second speaker; and performing an operation corresponding to the first speech command for an occupied seat by the speaker of the fourth conversation voice.

The speech recognizing method in a multi-speaker environment according to another embodiment of the present disclosure for solving the above-described technical problem may comprise: analyzing a conversation voice of a first speaker and a second speaker input through a microphone included in the computing system to determine a relation type between the first speaker and the second speaker; using the relation type to determine a list of speech commands permitted to the second speaker; and using the list of speech commands permitted to the second speaker to disregard at least a part of the speech commands uttered by the second speaker.

In some embodiments, using the list of speech commands permitted to the second speaker to disregard at least a part of the speech commands uttered by the second speaker may further comprise displaying on a screen an alarm indicating that the second speaker has no permission for the second speech command, if the second speech command uttered by the second speaker is disregarded.

In some embodiments, the method may further comprise: identifying a third speech command corresponding to an operation associated with a seat in a fifth conversation voice uttered by the first speaker or the second speaker; and performing an operation corresponding to the third speech command for an occupied seat by the speaker of the fifth conversation voice.

In some embodiments, the method may further comprise defining a list of speech commands which are allowed for each of the relation types between the first speaker and the second speaker, based on user input.

In some embodiments, the method further comprises: receiving input from a sixth conversation voice uttered by the first speaker or the second speaker; identifying that the sixth conversation voice corresponds to a fourth speech command, while identifying that the sixth conversation voice does not include a first parameter necessary to perform an operation corresponding to the fourth speech command; outputting a TTS voice to query the first parameter as a voice; and a step of, in response to receiving a seventh conversation voice from a speaker of the sixth conversation voice including the first parameter, performing an operation corresponding to the fourth speech command using the first parameter.

In some embodiments, the method may further comprise transforming the value of the first parameter based on a role in the relation type of the speaker of the seventh conversation voice.

To address the above technical problems, a computing system according to another embodiment of the present disclosure comprises one or more processors and a memory storing a computer program executable by the one or more processors. The computer program may be stored on a computer-readable recording medium to perform: analyzing a first conversation voice of a first speaker and a second speaker input through a microphone included in the computing system to determine a relation type between the first speaker and the second speaker; receiving input of the first conversation voice uttered by the first speaker or the second speaker, and determining a role of the speaker in the relation type through semantic analysis of the input conversation voice; extracting a voice feature of the input first conversation voice and determining the extracted voice feature as a voice feature of a speaker of the determined role; inputting a second conversation voice uttered by the first speaker or the second speaker, and determining the role of the speaker of the second conversation voice in the relation type by using the voice feature extracted from the second conversation voice; and determining a personalized service corresponding to the second conversation voice by using the role of the speaker of the second conversation voice in the relation type.

In some embodiments, the computer program may be stored on a computer-readable recording medium for further executing: displaying on a screen a script obtained as a result of Speak-To-Text (STT) processing of an utterance by the first speaker or the second speaker; receiving a selection input for a third conversation voice uttered by the second speaker included in the script; and determining a role in a relation type for the second speaker based on the information entered for the third conversation voice.

In some embodiments, the computer program may be stored on a computer-readable recording medium for further executing: identifying that an utterance of the first speaker or an utterance of the second speaker has not been received for a reference time or more; inputting the script into a first artificial neural network and, based on the output of the first artificial neural network, outputting a text to speech (TTS) voice generated by the first artificial neural network as a voice.

In some embodiments, the computer program may be stored on a computer-readable recording medium for further executing: identifying a first speech command corresponding to an operation associated with a seat in a fourth conversation voice uttered by the first speaker or the second speaker; and performing an operation corresponding to the first speech command on an occupied seat by the speaker of the fourth conversation voice.

To address the above technical problems, a computing system according to another embodiment of the present disclosure comprises one or more processors and a memory storing a computer program executable by the one or more processors. The computer program may be stored on a computer-readable recording medium for executing: analyzing conversation voice of a first speaker and a second speaker input through a microphone included in the computing system to determine a relation type between the first speaker and the second speaker; using the relation type to determine a list of speech commands allowable for the second speaker; and using the list of speech commands allowable for the second speaker to disregard at least a part of the speech commands uttered by the second speaker.

In some embodiments, the computer program may be stored on a computer-readable recording medium. For using the list of speech commands allowable for the second speaker to disregard at least a part of the speech commands uttered by the second speaker, the computer program performs displaying on a screen an alarm indicating that the second speaker has no permission for the second speech command.

In some embodiments, the computer program may be stored on a computer-readable recording medium for further executing: identifying a third speech command corresponding to an operation associated with a seat in a fifth conversation voice uttered by the first speaker or the second speaker; and performing an operation corresponding to the third speech command on an occupied seat by the speaker of the fifth conversation voice.

In some embodiments, the computer program may be stored on a computer-readable recording medium for further executing defining a list of speech commands which are permitted for each of the types of relations between the first speaker and the second speaker based on user input.

In some embodiments, the computer program may be stored on a computer-readable recording medium for further executing: receiving input of a sixth conversation voice uttered by the first speaker or the second speaker; identifying that the sixth conversation voice corresponds to a fourth speech command while identifying that the sixth conversation voice does not include a first parameter necessary to perform an operation corresponding to the fourth speech command; outputting a TTS voice to query the first parameter as a voice; and a step of, in response to receiving a seventh conversation voice from a speaker of the sixth conversation voice including the first parameter, performing an operation corresponding to the fourth speech command by using the first parameter.

In some embodiments, the computer program may be stored on a computer-readable storage medium for further executing converting the value of the first parameter based on a role in the relation type of the speaker of the seventh conversation voice.

### BRIEF DESCRIPTION OF DRAWINGS

FIG. 1 is a diagram illustrating an example environment in which a navigation system according to an embodiment of the present disclosure may be applied.

FIG. 2 is a flowchart of a speech recognizing method for a multi-speaker environment according to another embodiment of the present disclosure.

FIG. 3 is a diagram for illustrating a step of determining a relation type between a driver and a passenger which may be performed in some embodiments of the present disclosure.

FIG. 4 is a diagram for illustrating a step for determining a driver or passenger's role within the relation type, which may be performed in some embodiments of the present disclosure.

FIG. 5 is a diagram for illustrating a step for determining a role in a relation type of a conversation voice speaker by using voice features, which may be performed in some embodiments of the present disclosure.

FIG. 6 is a diagram for illustrating a step for determining a role within a relation type of a passenger based on user input, which may be performed in some embodiments of the present disclosure.

FIG. 7 is a flowchart of a speech recognizing method for a multi-speaker environment according to another embodiment of the present disclosure.

FIG. 8 is a diagram for illustrating a step of disregarding a speech command of a conversation voice if the speaker of the conversation voice has no permission for the speech command contained in the conversation voice, which may be performed in some embodiments of the present disclosure.

FIG. 9 is a diagram for illustrating a step of displaying on a screen an alarm indicating that a passenger has no permission for a speech command, which may be performed in some other embodiments of the disclosure.

FIG. 10 is a diagram illustrating a step for outputting a TTS voice to query a parameter corresponding to a speech command, which may be performed in some embodiments of the present disclosure.

FIG. 11 is a hardware configuration diagram of a computing system according to another embodiment of the present disclosure.

### DESCRIPTION OF EMBODIMENTS

Hereinafter, preferred embodiments of the present disclosure will be described in detail with reference to the accompanying drawings. The advantages and features of the present invention, and methods of achieving the same will become apparent with reference to the embodiments described in detail with the accompanying drawings. However, the technical idea of the present invention is not limited to the following embodiments, but may be implemented in various different forms, and the following embodiments are provided only to complete the technical idea of the present invention and to fully inform those skilled in the art, to which the present invention pertains, of the scope of the present invention, and the technical idea of the present invention is only defined by the scope of the claims.

In describing the present disclosure, when it is determined that a detailed description of a related known configuration or function may obscure the subject matter of the present disclosure, the detailed description will be omitted.

Unless otherwise defined, terms (including technical and scientific terms) used in the following embodiments may be used in a sense commonly understood by those skilled in the art to which the present disclosure pertains, but may vary according to the intention or precedent of a technician working in an associated field, the emergence of new technology, and the like. The terms used in the present disclosure are intended to describe embodiments and are not intended to limit the scope of the present disclosure.

The singular expression used in the following embodiments includes plural concepts, unless the context clearly specifies that it is singular. In addition, the plural expressions include a singular concept unless the context clearly specifies that it is plural.

In addition, the terms first, second, A, B, (a), (b), and the like used in the following embodiments are merely used to distinguish an element from another element, and the nature, sequence, or order of the element is not limited by the terms.

Prior to the description of various embodiments of the present disclosure, the terminology used in the following embodiments shall be clarified.

In the following embodiments, a “conversation voice” may refer to an utterance of a particular occupant in a mobility device.

In the following embodiments, “relation type” may mean an identifier which distinguishes each of a plurality of relations which may be established between a driver and a passenger predefined in the navigation system. For embodiment, the relation type may comprise married couple, father and son, lovers, friends, etc.

Hereinafter, some embodiments of the present disclosure will be described with reference to the drawings.

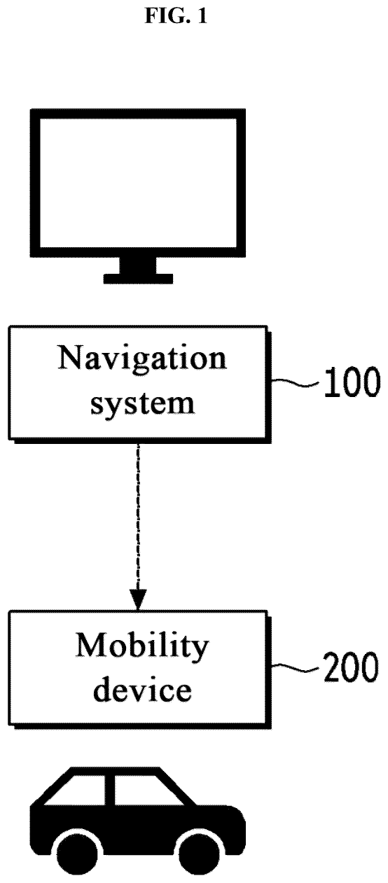

FIG. 1 illustrates an embodiment environment in which a navigation system may be applied according to an embodiment of the present disclosure.

In some embodiments, the navigation system (100) may communicate with other components over a network. The network may be implemented as any type of wired/wireless network such as a Local Area Network (LAN), a Wide Area Network (WAN), a mobile radio communication network, and a Wireless Broadband Internet (Wibro).

In addition, the mobility device (200) shown in FIG. 1 may be any one of a vehicle, a locomotive, an electric vehicle, an autonomous vehicle, a bicycle, a shared kickboard, and an unmanned aerial vehicle (UAV). In addition, the usage power of the mobility device (200) may be an engine, electric power, wind power, tidal power, or the like.

Hereinafter, in describing some embodiments of the present disclosure, in order to help to understand of the embodiments of the present disclosure, it may be illustrated that a subject which receives a conversation voice from each of a plurality of speakers in an environment where there are the plurality of speakers, and performs an operation corresponding to a speech command included in the conversation voice is a navigation terminal or a navigation system, but the present disclosure is not limited to the same if it is any device which comprises a microphone such as a smart speaker, a television (TV), and a smartphone, at least one processor, and a memory, receives a user's utterance and performs a specific operation corresponding to a speech command included in the utterance by using the processor.

In an embodiment of the present disclosure, the navigation system (100) may be a navigation device provided in the mobility device (200), but in some embodiments of the present disclosure, the navigation system (100) may be configured as a server farm existing in a physical space different from that of the mobility device (200), perform an operation corresponding to a request in response to the request received from the navigation terminal provided in the mobility device (200), and transmit a result of performing the operation to the navigation terminal.

The navigation system (100) according to an embodiment of the present disclosure may determine a relation type between the driver and the passenger by analyzing a conversation voice of the driver and the passenger, which is input through a microphone positioned in a mobility device in which the driver and the passenger are riding. The relation type will be described in detail later.

In some embodiments of the present disclosure, the navigation system (100) may determine a relation type between the driver and the passenger based on keywords included in any one of the driver's and passenger's conversation voices.

In some other embodiments of the present disclosure, the navigation system (100) may determine a relation type between the driver and the passenger based on the results of a semantic analysis of the driver's and passenger's conversation voice.

The navigation system (100), in accordance with another embodiment of the present disclosure, may receive input of a first conversation voice uttered by the driver or the passenger, and may determine a role of the speaker in the relation type through semantic analysis of the input conversation voice.

In some embodiments of the present disclosure, performing a semantic analysis of the input conversation voice may comprise inputting the input conversation voice into a large language model (LLM) trained by the navigation system (100) using data including conversation voices between a plurality of speakers, and performing the semantic analysis based on data output from the LLM.

In some other embodiments of the present disclosure, for embodiment, one of the roles in the relation type may be a “father” and the other of the roles in the relation type may be a “child” when the relation type is a “father-child” relation.

The navigation system (100), according to another embodiment of the present disclosure, may extract a voice feature of the first conversation voice, and determine the extracted voice feature to be a voice feature of the occupant of the determined role.

In some embodiments of the present disclosure, for embodiment, the navigation system (100) may receive a conversation voice uttered by a occupant of the mobility device (200), determine that the relation type between the occupants of the mobility device (200) is a “father-child” relation, determine that the driver is a “father” based on a semantic analysis of a first conversation voice uttered by the driver, and determine that a voice feature of the first conversation voice is a voice feature of the “father”.

The navigation system (100), in accordance with another embodiment of the present disclosure, may receive input of a second conversation voice uttered by the driver or the passenger, and may use voice features extracted from the second conversation voice to determine a role in the relation type of the speaker of the second conversation voice.

In some embodiments of the present disclosure, for embodiment, the navigation system (100) may determine that the driver is a “father” based on a semantic analysis of a first conversation voice uttered by the driver, and that the second conversation voice uttered by the driver is uttered by the “father” in response to a determination that the second conversation voice has the same voice features as the first conversation voice when it is determined that the voice features of the first conversation voice are voice features of the “father”.

The navigation system (100), in accordance with another embodiment of the present disclosure, may determine a personalized service corresponding to the second conversation voice by sing a role in the relation type of the speaker of the second conversation voice, which will be described later.

The navigation system (100), according to another embodiment of the present disclosure, may use the relation type to determine a list of speech commands which are allowed for the passenger.

In some embodiments of the present disclosure, for embodiment, the navigation system (100) may determine not to perform an operation in response to a speech command from a passenger to change a driving mode, or a destination setting speech command, when the relation type is a “father-child” relation.

The navigation system (100) according to another embodiment of the present disclosure may utilize a list of speech commands allowable to the passenger to disregard at least some of the speech commands uttered by the passenger, which will be described in detail later.

Until now, the components included in the exemplary environment, to which the navigation system (100) may be applied, and the operations which the components may perform have been described with reference to FIG. 1. It should be understood that the embodiments described above are exemplary in all aspects and are not limited thereto. In addition, the configuration and operation of the navigation system (100) according to the embodiments of the present disclosure may be supplemented by some embodiments described later.

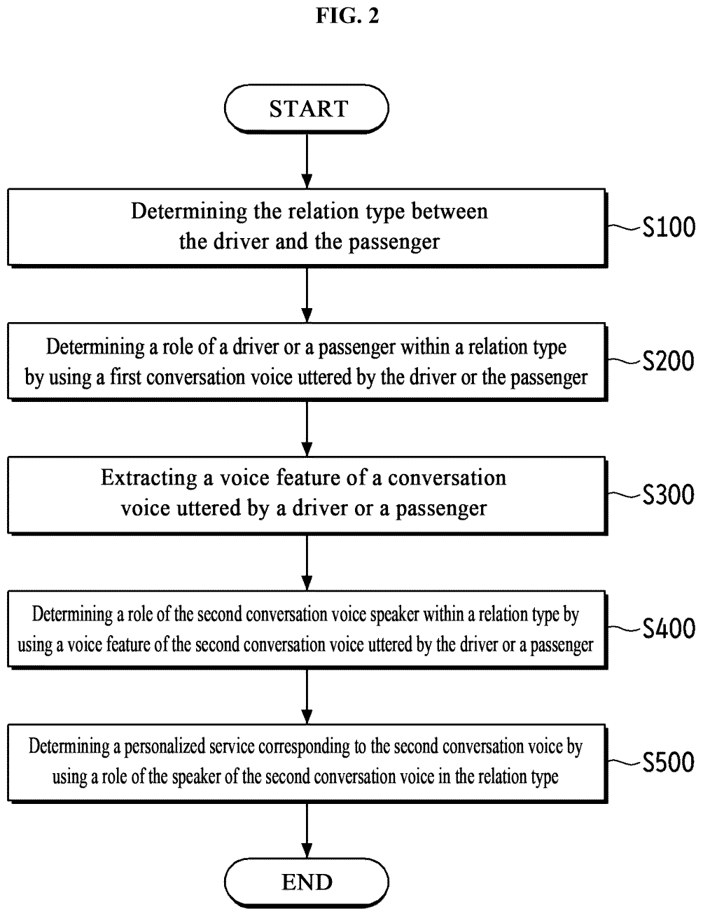

Hereinafter, a speech recognizing method in a multi-speaker environment according to another embodiment of the present disclosure will be described with reference to FIGS. 2 to 6. Hereinafter, it may be understood that steps to be described in some flowcharts are performed by the navigation system (100) described with reference to FIG. 1 unless otherwise noted. In addition, it is sure that the technical idea which may be understood in the embodiment described above with reference to FIG. 1 can be obviously applied to the speech recognizing method in a multi-speaker environment according to the embodiment of the present disclosure.

In a step S100, the navigation system (100) may determine a relation type between the driver and the passenger by analyzing a conversation voice of the driver and the passenger inputted through a microphone located on the mobility device in which the driver and passenger are riding.

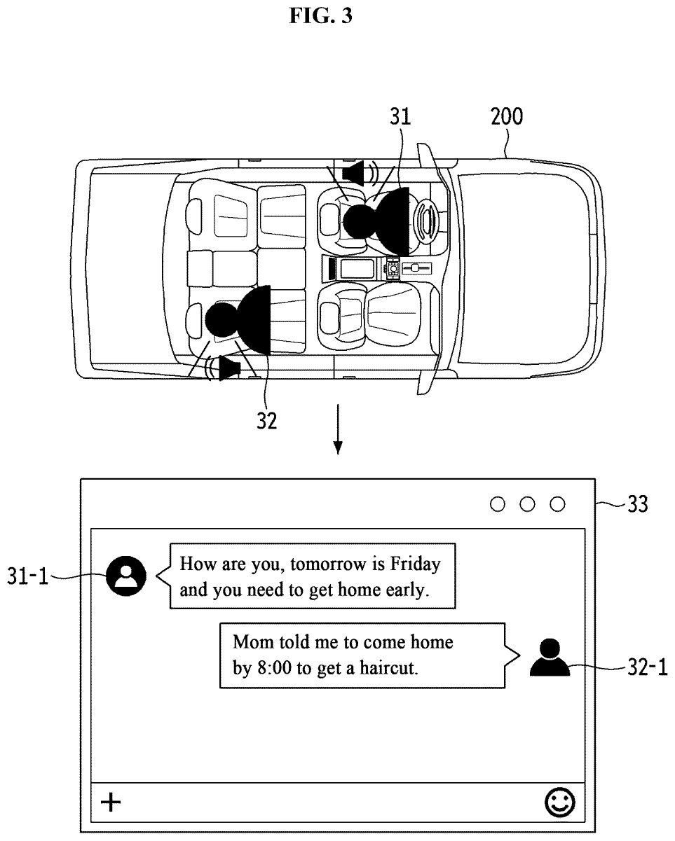

In some embodiments associated with the step S100, referring to FIG. 3, the navigation system (100) may display a first conversation record (33) obtained as a result of STT (Speech-To-Text) processing of the utterances of the first driver (31) and the first passenger (32), who are occupants of the mobility device (200), on a display device provided on the mobility device (200).

In some embodiments associated with the step S100, referring to FIG. 3, the navigation system (100) may perform a semantic analysis of the first conversation voice (31-1) of the first driver (31) and the second conversation voice (32-1) of the first passenger (32) inputted via a microphone (not shown) located on the mobility device (200), and determine that the relation type of the first driver (31) and the first passenger (32) is “parent and child” based on the results of performing the semantic analysis. Here, the semantic analysis method is not limited to any one of the semantic analysis methods for the text used in the natural language processing technology field of the related art.

In some other embodiments according to the step S100, referring to FIG. 3, the navigation system (100) may determine that the relation type of the first driver (31) and the first passenger (32) is “parent and child” in response to a determination that the second conversation voice (32-1) of the first passenger (32) inputted through a microphone (not shown) located on the mobility device (200) includes the keyword “mom”.

In a step S200, the navigation system (100) may receive input of a first conversation voice uttered by the driver or the passenger and determine a role of the speaker in the relation type through semantic analysis of the inputted conversation voice.

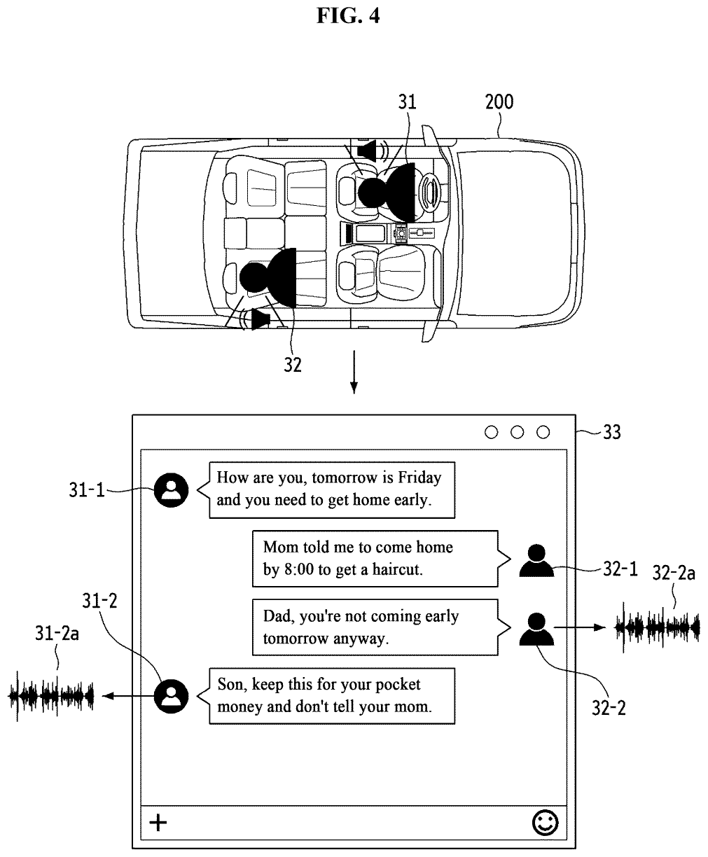

Hereinafter, with reference to FIG. 4, it may be understood that FIG. 4 illustrates a situation in which a third conversation voice (32-2) of the first passenger (32) and a fourth conversation voice (31-2) of the first driver (31) are additionally received after the time point of FIG. 3.

In some embodiments related to the step S200, referring to FIG. 4, the navigation system (100) may receive the input of the third conversation voice (32-2) of the first passenger (32) and determine that the role of the first passenger (32) within the “parent and child” relation type of the first driver (31) and the first passenger (32) is “child” based on the information that the third conversation voice (32-2) includes the keyword “dad”.

In some other embodiments associated with the step S200, referring to FIG. 4, the navigation system (100) may receive input of the fourth conversation voice (31-2) of the first driver (31) and determine that the role of the first driver (31) within the “parent and child” relation type of the first driver (31) and the first passenger (32) is “parent,” based on information that the fourth conversation voice (31-2) includes the keyword “son”.

In a step S300, the navigation system (100) may extract voice features of a conversation voice uttered by the driver or passenger. Here, the operation of extracting the voice features is not limited to any one of the conventional voiceprint analysis methods.

In some embodiments associated with the step S300, referring to FIG. 4, the navigation system (100) may extract the voice feature (32-2a) of the third conversation voice (32-2) of the first passenger (32) and determine that the voice feature (32-2a) of the third conversation voice (32-2) is the voice feature of “child”.

In some other embodiments associated with the step S300, referring to FIG. 4, the navigation system (100) may extract the voice feature (31-2a) of the fourth conversation voice (31-2) of the first driver (31) and determine that the voice feature (31-2a) of the fourth conversation voice (31-2) is the voice feature of the “parent”.

In a step S400, the navigation system (100) may determine a role in the relation type of the conversation voice speaker by using voice features of the second conversation voice uttered by the driver or passenger.

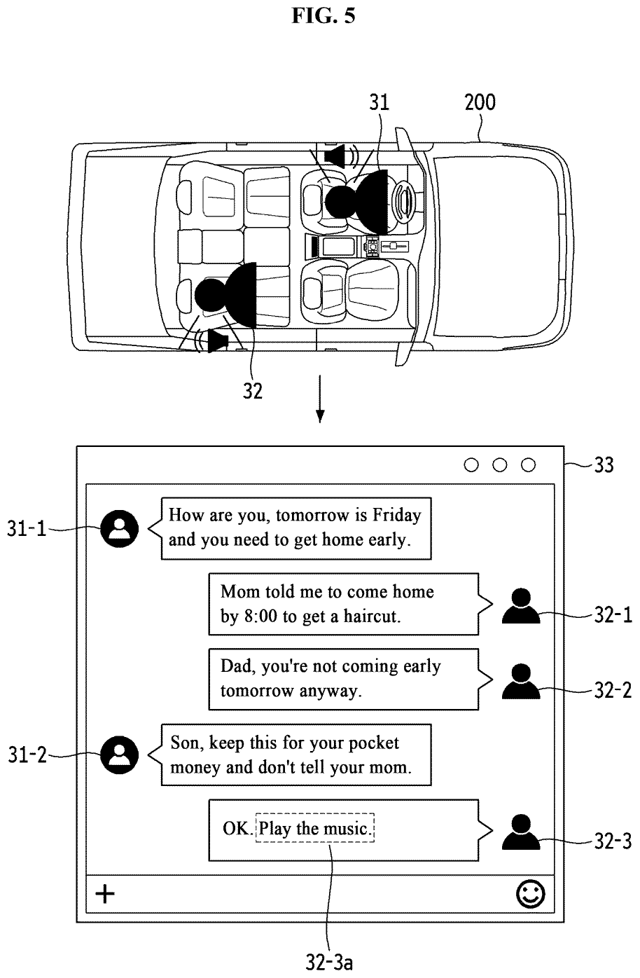

In the following description with reference to FIG. 5, it may be understood that FIG. 5 illustrates a situation in which a fifth conversation voice (32-2) of the first passenger (32) is additionally received after the time point of FIG. 4.

In some embodiments associated with the step S400, referring to FIG. 5, the navigation system (100) may receive input of a fifth conversation voice (32-2) of the first passenger (32) and determine that the fifth conversation voice (32-2) is a conversation voice of the “child” based on determining that the input fifth conversation voice (32-2) corresponds to a voice feature of the “child” determined in the step S300.

In a step S500, the navigation system (100) may determine a personalized service corresponding to the role of the speaker of the second conversation voice received in the step S400 based on the role in the relation type of the speaker of the second conversation voice.

In some embodiments associated with the step S500, referring to FIG. 5, the navigation system (100) may play music included in a playlist corresponding to a group of teenagers in response to receiving input of a fifth conversation voice (32-2) from the first passenger (32) and receiving a speech command (32-2a) for playing music included in the fifth conversation voice (32-2) based on the determination that the received fifth conversation voice (32-2) is a conversation voice of a “child”. However, when the first driver (31) utters a conversation voice including a speech command (32-2a) for playing music, music included in a playlist corresponding to the 40s or 50s age group may be played in response to the speech command.

In another several embodiments associated with the step S500, referring to FIG. 5, the navigation system (100) may perform an operation of placing a call to a contact corresponding to the wife of the first driver (31) based on receiving input of a conversation voice of the first passenger (32) and determining that the conversation voice of the first passenger (32) includes a speech command for placing a call and a parameter of the speech command for placing a call is “mom”.

In another several embodiments associated with the step S500, referring to FIG. 5, the navigation system (100) may perform the operation of placing a call to a contact corresponding to the mother of the first driver (31), i.e., grandmother of the first passenger (32) based on receiving input of a conversation voice of the first driver (31) and determining that the conversation voice of the first driver (31) includes a speech command for placing a call and a parameter of the speech command for placing a call is “mom”.

According to the present embodiment, a user may obtain the effect of not having to perform additional user input to the navigation system (100) because an operation performed by the navigation system (100) in response to a speech command deviated from the intention of the user.

In another several embodiments associated with the step S500, referring to FIG. 5, the navigation system (100) may input the first conversation record (33) into a first artificial neural network based on a determination that no additional conversation voices are received for a reference time or more after the fifth conversation voice (32-3) from the first passenger (32) is received, and may output the text “Would you like me to read your dad's schedule for tomorrow?” as a TTS voice based on the output of the first artificial neural network.

According to the present embodiment, the effect of preventing drowsy driving by the driver may be achieved by the navigation system (100) inducing a new conversation in a situation where the conversation between the driver and passenger is disconnected.

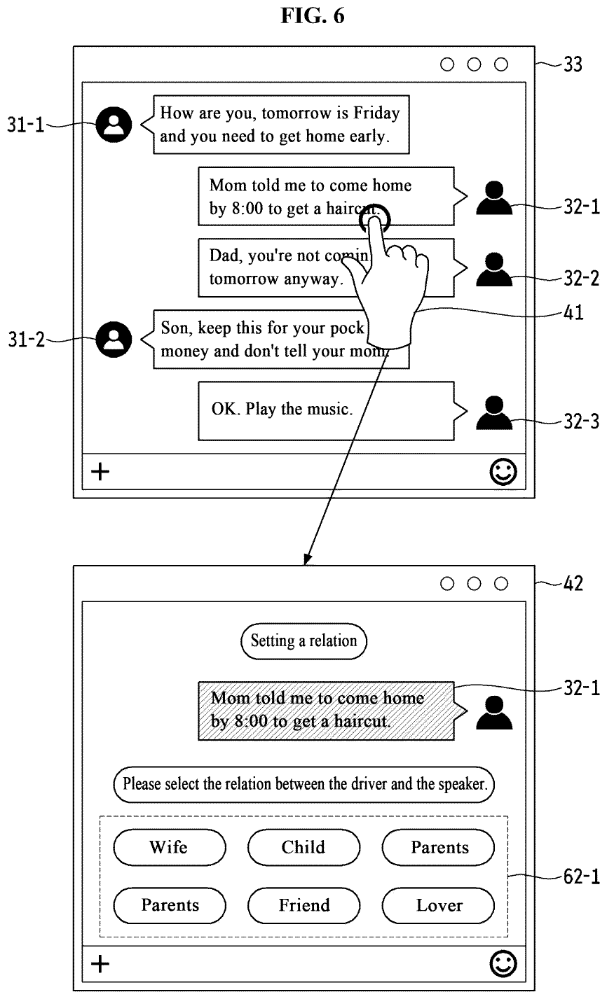

In another several embodiments associated with the step S500, referring to FIG. 6, the navigation system (100) may display the first relation type setting interface (42) via a display device provided within the mobility device (200) in response to receiving a selection input for the second conversation voice (32-1) of the first passenger (32) by an occupant of the mobility device (200).

Additionally, the relation type information between the first driver (31) and the first passenger (32) may be changed in response to an input of the occupant to any of a first set of relation type buttons (62-1) included in the first relation type setting interface (42).

The speech recognizing method in a multi-speaker environment according to another embodiment of the present disclosure has been described with reference to FIGS. 2 to 6. It should be understood that the embodiments described above are exemplary in all aspects and are not limited thereto.

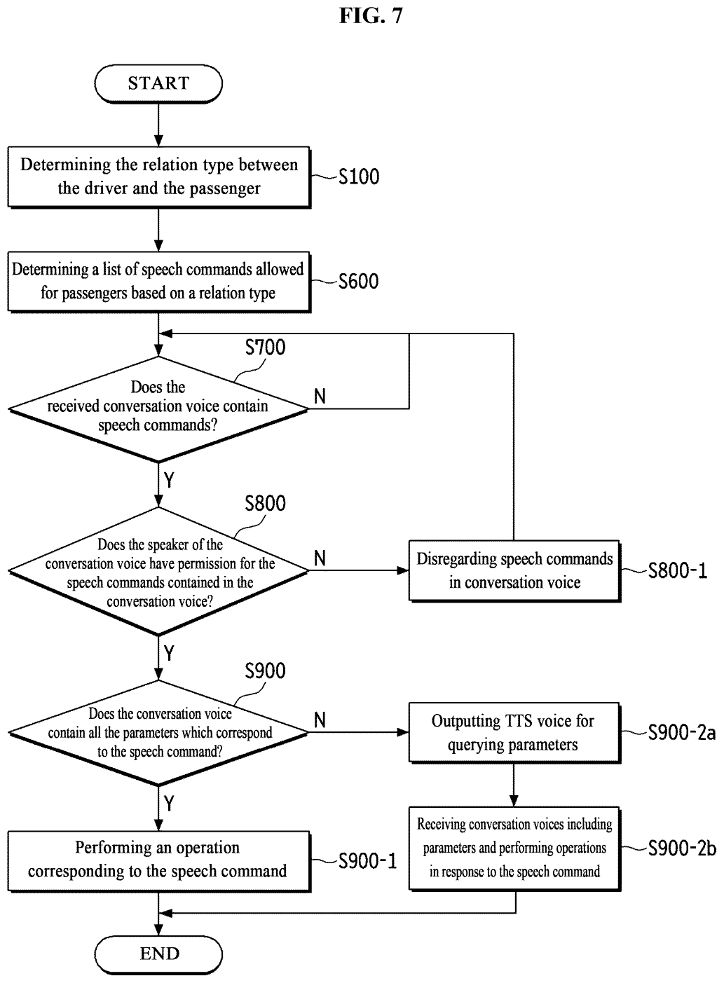

Hereinafter, the speech recognizing method in a multi-speaker environment according to another embodiment of the present disclosure will be described with reference to FIGS. 7 to 10. The steps described in the following several flowcharts may be understood to be performed by the navigation system (100) described with reference to FIG. 1 unless otherwise noted. In addition, to the speech recognizing method in a multi-speaker environment according to the present embodiment, the technical idea which may be understood in the embodiment described above with reference to FIG. 1. can be obviously applied.

In the step S100, illustrated in FIG. 7, the navigation system (100) may determine a relation type between the driver and the passenger by analyzing the conversation voice the driver and passenger input through a microphone located on the mobility device in which the driver and passenger are riding. Some of the embodiments associated with the step S100 will be clearly understood with reference to some of the embodiments associated with the step S100 described with reference to FIG. 2.

Next, in a step S600, the navigation system (100) may determine a list of speech commands allowed for the passenger based on the relation type between the driver and the passenger in the mobility device.

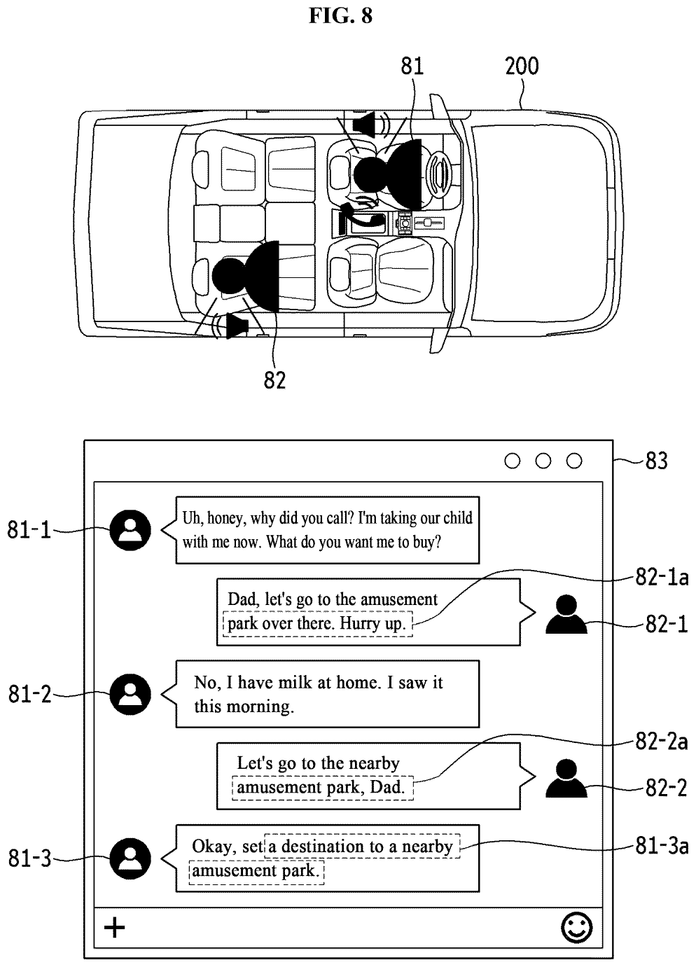

In some embodiments associated with the step S600, referring to FIG. 8, as a result of analyzing the second conversation record (83) including the sixth conversation voice (81-1), the seventh conversation voice (82-1), the eighth conversation voice (81-2), the ninth conversation voice (82-2), and the tenth conversation voice (81-3) uttered by the second driver (81) and the second passenger (82) who are the occupants of the mobility device (200), respectively, when the relation type between the second driver (81) and the second passenger (82) is identified as “parent and child”, the navigation system (100) may determine to perform only an operation corresponding to the speech command of the air conditioner control, the speech command of the seat heating control, and the speech command of the music playback among the speech commands included in the conversation voice uttered by the second passenger (82).

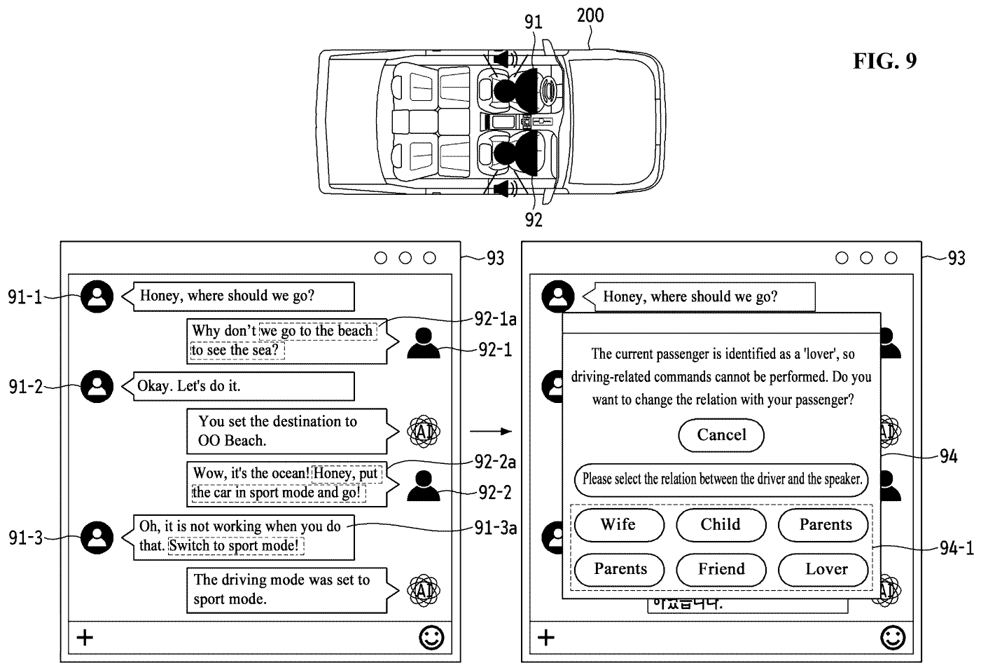

In some other embodiments associated with the step (S600), referring to FIG. 9, when the relation type of the third driver (91) and the third passenger (92) is identified as “lovers” as a result of analyzing the third conversation record (93) comprising the eleventh conversation voice (91-1), the twelfth conversation voice (92-1), the thirteenth conversation voice (91-2), the fourteenth conversation voice (92-2), and the fifteenth conversation voice (91-3) uttered by the third driver (91) and the third passenger (92) who are the occupants of the mobility device (200), the navigation system (100) may determine that only the operation corresponding to the speech command of the air conditioner control, the speech command of the seat heating control, the speech command of the music playback, and the destination setting speech command among the speech commands uttered by the third passenger (92) is performed.

In a step S700, the navigation system (100) may determine whether the conversation voice received from the driver or passenger comprises a speech command.

In some embodiments associated with the step S700, referring to FIG. 8, the navigation system (100) may identify that the seventh conversation voice (82-1) of the second passenger (82) comprises a first destination setting speech command (82-1a).

In some other embodiments associated with the step S700, referring to FIG. 8, the navigation system (100) may identify that the ninth conversation voice (82-2) of the second passenger (82) comprises a second destination setting speech command (82-1a).

In some other embodiments associated with the step S700, referring to FIG. 8, the navigation system (100) may identify that the tenth conversation voice (81-3) of the second driver (81) comprises the third destination setting speech command (81-3a).

In some other embodiments associated with the step S700, referring to FIG. 9, the navigation system (100) may identify that the fourth destination setting speech command (92-1a) is included in the twelfth conversation voice (92-1) of the third passenger (92).

In some other embodiments associated with the step S700, referring to FIG. 9, the navigation system (100) may identify that the fourteenth conversation voice (92-2) of the third passenger (92) comprises a first driving mode change speech command (92-2a).

In some other embodiments associated with the step S700, referring to FIG. 9, the navigation system (100) may identify that the second driving mode change speech command (91-3a) is included in the fifteenth conversation voice (91-3) of the third driver (91).

In a step S800, when the conversation voice received from the driver or the passenger comprises a speech command, the navigation system (100) may determine whether the speaker of the conversation voice has a permission for the speech command.

In a step S800-1, the navigation system (100) may disregard the speech command included in the conversation voice when it is determined that the utterer of the conversation voice in the step S800 does not have the permission for the speech command.

In a step S900, the navigation system (100) may determine whether all parameters for performing an operation on the speech command included in the received conversation voice are included in the conversation voice. A case where all parameters for performing the operation for the speech command included in the received conversation voice are not included in the conversation voice will be described in detail later.

In a step S900-1, the navigation system (100) may perform an operation corresponding to the speech command according to a determination that all parameters for performing the operation for the speech command included in the received conversation voice are included in the conversation voice.

In some embodiments associated with the step S800 and the step S800-1, referring to FIG. 8, the navigation system (100) may disregard the first destination setting speech command (82-1a) and do not perform an operation corresponding to the first destination setting speech command (82-1a) based on the information in which the seventh conversation voice (82-1) of the second passenger (82) comprises the first destination setting speech command (82-1a), but the second passenger (82) is an occupant who has no permission for the destination setting speech command. In addition, even when the ninth conversation voice (82-2) of the second passenger (82) illustrated in FIG. 8 comprises the second destination setting speech command (82-1a), the navigation system (100) may operate in the same manner as in the above-described embodiment.

If the destination set in the navigation system (100) is arbitrarily changed by a speech command of a passenger without the driver's consent, the navigation system (100) may deviate to an incorrect route, resulting in a situation where the ETA (Estimated Time Arrival) for the destination, to which the driver is trying to reach, is delayed. According to the present embodiment, the navigation system (100) may achieve the effect of preventing situations resulting in driver confusion by limiting situations in which the navigation system (100) performs operations in response to a speech command of a passenger to change a destination without the driver's consent.

In some other embodiments associated with the steps S800 and S800-1, referring to FIG. 9, the navigation system (100) may disregard the first driving mode change speech command (92-2a) and do not perform an operation corresponding to the first driving mode change speech command (92-2a) based on information in which the fourteenth conversation voice (92-2) of the third passenger (92) comprises the first driving mode change speech command (92-2a), but the third passenger (92) is an occupant who has no permission for the driving mode change speech command.

If the driving mode of the mobility device (200) is arbitrarily changed by a speech command of a passenger without the consent of the driver, a situation may arise in which the acceleration and deceleration capabilities of the mobility device (200) change without the awareness of driver, causing danger to the occupants of the mobility device (200). According to the present embodiment, the navigation system (100) may achieve the effect of preventing situations which jeopardize the safety of occupants of the mobility device (200) by limiting situations in which operations in response to a speech command to change the driving mode of a passenger are performed without the consent of the driver.

In some other embodiments associated with the steps S800 and S800-1, referring to FIG. 9, the navigation system (100) may display a second relation type setting interface (94) overlaying a third conversation history (93) screen displayed on a display device provided in the mobility device (200) when the first driving mode change speech command (92-2a) contained in the fourteenth conversation voice (92-2) of the third passenger (92) is disregarded.

In addition, the navigation system (100) may change the list of speech commands allowed for the third passenger (92) by changing the relation type information between the third driver (91) and the third passenger (92) in response to the input of the occupant to any one of the second relation type button sets (94-1) included in the second relation type setting interface (94).

According to an embodiment, an occupant of the mobility device (200) may respond to a situation in which the navigation system (100) has incorrectly set the relation type between the driver and the passenger.

In some embodiments associated with the steps S800, S900, and S900-1, referring to FIG. 8, the tenth conversation voice (81-3) of the second driver (81) comprises a third destination setting speech command (81-3a), the tenth conversation voice (81-3) comprises “amusement park” as information for a place parameter, which is a parameter required to perform the destination setting speech command, and based on the information in which the second driver (81) is an occupant having a permission for the destination setting speech command, the navigation system (100) may perform an operation of setting the amusement park closest to the location of the mobility device (200) as the destination.

In some other embodiments associated with the steps S800, S900, and S900-1, referring to FIG. 9, a twelfth conversation voice (92-1) from the third passenger (92) comprises a fourth destination setting speech command (92-1a), the twelfth conversation voice (92-1) comprises “beach” as information for a place parameter, which is a parameter required to perform the destination setting speech command, and based on information in which the third passenger (92) is an occupant with permission for the destination setting speech command, the navigation system (100) may perform the operation of setting the beach nearest to the location of the mobility device (200) as a destination.

In another other embodiments associated with the steps S800, S900, and S900-1, referring to FIG. 9, a fifteenth conversation voice (91-3) from the third driver (91) comprises a second driving mode change speech command (91-3a), the fifteenth conversation voice (91-3) comprises a “sport mode” as information for a mode identifier parameter, which is a parameter necessary to perform the driving mode change speech command, and based on information in which the third driver (91) is an occupant with permission for the driving mode change speech command, the navigation system (100) may perform an operation to change the driving mode of the mobility device (200) to a sport mode.

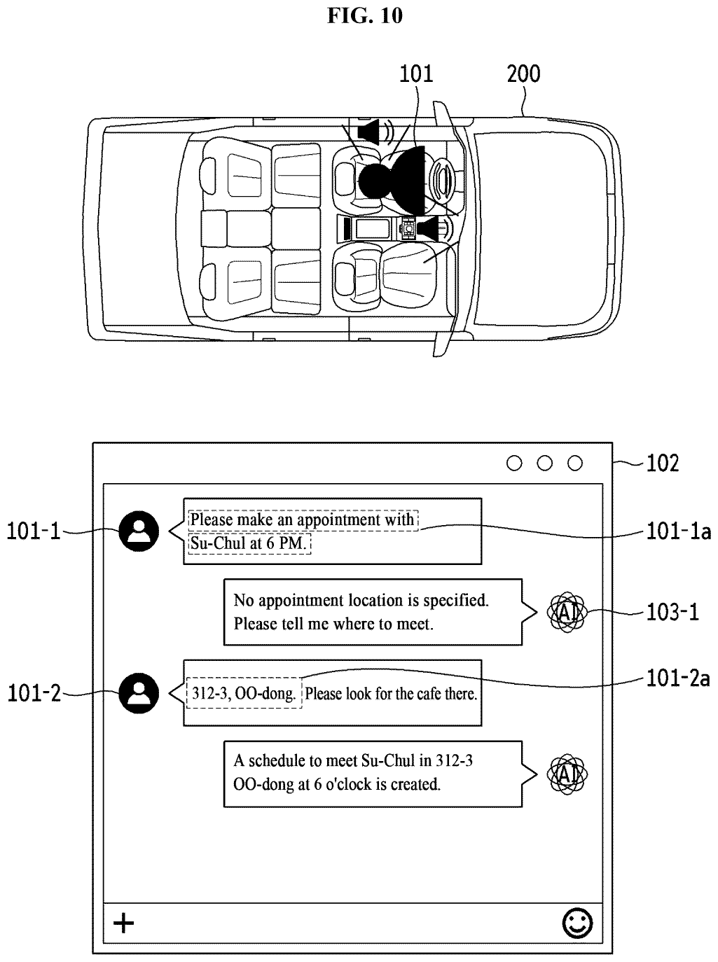

Hereinafter, referring to FIG. 10, described will be a case in which all parameters for performing the operation for the speech command included in the conversation voice received in the step S900 are not included in the conversation voice.

In a step S900-2a, the navigation system (100) may output a TTS voice using a speaker of the mobility device (200) to query for the absent parameters from the conversation voice, if the received conversation voice is identified to include a speech command, but the conversation voice does not comprise parameters for performing an operation in response to the speech command.

In some embodiments associated with the step S900-2a, referring to a fourth conversation record (102) of FIG. 10, the navigation system (100) identifies that the sixteenth conversation voice (101-1) of the fourth driver (101) comprises a first scheduling speech command (101-1a). In response to determination that the sixteenth conversation voice (101-1) does not comprise a place parameter necessary to perform an operation corresponding to the scheduling speech command, the navigation system (100) may output a TTS voice (103-1) querying the place parameter by using a speaker of the mobility device (200).

In a step S900-2b, the navigation system (100) may receive a conversation voice comprising information about the parameters provided by the user in response to the TTS voice output in the above step S900-2, and may perform an operation corresponding to a speech command of the conversation voice based on the information about the parameters contained in the conversation voice.

In some embodiments associated with the step S900-2b, referring to FIG. 10, the navigation system (100) may receive a seventeenth conversation voice (101-2) from the fourth driver (101) including an address parameter (101-2a), which is a parameter required to perform an operation corresponding to the first scheduling speech command (101-1a), and may perform an operation corresponding to the first scheduling speech command (101-1a), which is an operation to generate schedule information, based on the address parameter (101-2a).

The speech recognizing method in a multi-speaker environment according to another embodiment of the present disclosure has been described with reference to FIGS. 7 to 10. It should be understood that the embodiments described above are exemplary in all aspects and are not limited thereto.

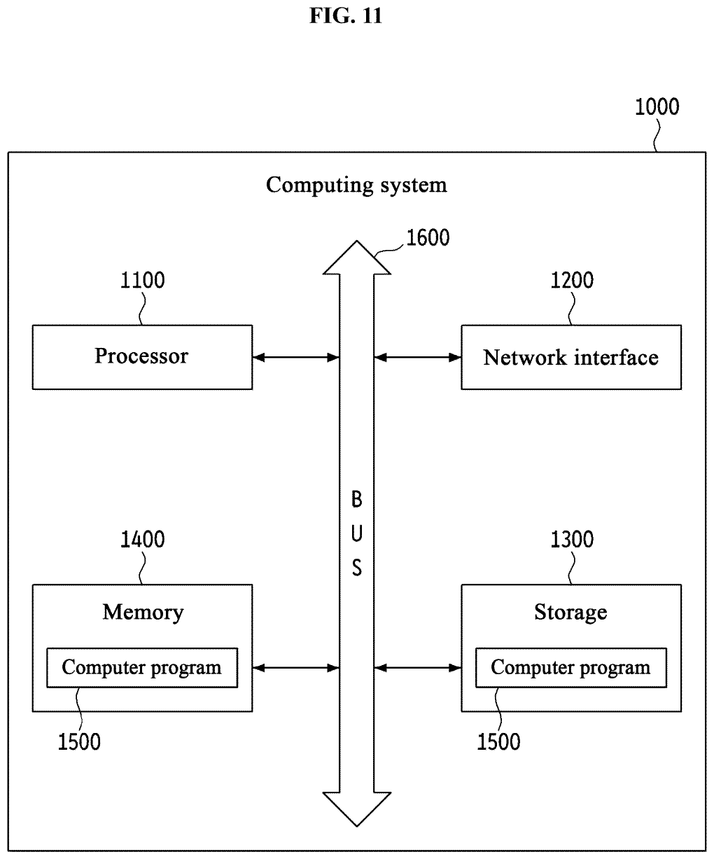

FIG. 11 is a hardware configuration diagram of a computing system (1000) according to some embodiments of the present disclosure. The computing system (1000) of FIG. 11 may refer to, for example, the navigation system (100) described with reference to FIG. 1. In another embodiment, the computing system (1000) of FIG. 11 may comprise one or more processors (1100), a system bus (1600), a communication interface (1200), a memory (1400) for loading a computer program (1500) executed by the processors (1100), and a storage (1300) for storing the computer program (1500).

The processor (1100) controls the overall operation of each component of the computing system (1000). The processor (1100) may perform an operation on at least one application or program for executing a method/operation according to various embodiments of the present disclosure. The memory (1400) stores various data, commands, and/or information. The memory (1400) may load one or more computer programs (1500) from the storage (1300) to execute methods/operations according to various embodiments of the present disclosure. The bus (1600) provides a communication function between the components of the computing system (1000). The communication interface (1200) supports Internet communication of the computing system (1000). The storage (1300) may non-temporarily store one or more computer programs (1500). The computer program (1500) may comprise one or more instructions in which methods/operations according to various embodiments of the present disclosure are implemented. Once the computer program (1500) is loaded into the memory (1400), the processor (1100) may execute the one or more instructions to perform methods/operations according to various embodiments of the present disclosure.

In some embodiments, the computing system (1000) described with reference to FIG. 11 may be configured using one or more physical servers included in a server farm based on cloud technology such as virtual machines. In the case, at least some of the components illustrated in FIG. 11, such as the processor (1100), the memory (1400), and the storage (1300), may be virtual hardware, and the communication interface (1200) may also comprise virtualized networking elements such as virtual switches.

A computer program (1500) according to some embodiments of the present disclosure my comprise an instruction for executing the steps of: determining a relation type between a driver and a passenger by analyzing a conversation voice of the driver and the passenger inputted through a microphone located on a mobility device in which the driver and the passenger are riding; receiving an input of a first conversation voice uttered by the driver or the passenger, and determining a role of the speaker in the relation type by semantic analysis of the inputted conversation voice; extracting a voice feature of the inputted first conversation voice and determining the extracted voice feature as a voice feature of the occupant of the determined role; receiving an input of a second conversation voice uttered by the driver or the passenger, and determining a role in the relation type of the speaker of the second conversation voice by using the voice feature extracted from the second conversation voice; and determining a personalized service corresponding to the second conversation voice by using the role in the relation type of the speaker of the second conversation voice.

Various embodiments of the present disclosure and effects of such embodiments have been described herein with reference to FIGS. 1 through 11. The effects according to the technical idea of the present disclosure are not limited to the effects mentioned above, and other effects not mentioned will be clearly understood by those skilled in the art from the following description.

The technical idea of the present disclosure described so far may be implemented as computer-readable code on a computer-readable medium. The computer program recorded in the computer-readable recording medium may be transmitted to another computing device through a network such as the Internet to be installed in the other computing device, and thus may be used in the other computing device.

Although the operations are shown in a particular order in the drawings, it should not be understood that the operations must be executed in the particular order shown or in sequential order or all shown operations must be executed in order to achieve the desired results. In certain situations, multitasking and parallel processing may be advantageous. Although embodiments of the disclosure have been described above with reference to the accompanying drawings, those skilled in the art, to which the disclosure pertains, may understand that the disclosure may be implemented in other specific forms without changing the technical idea or essential features. Therefore, it should be understood that the embodiments described above are exemplary in all aspects and are not limited thereto. The protection scope of the present invention should be interpreted by the following claims, and all technical ideas within the scope equivalent thereto should be interpreted to be included in the scope of rights of the technical idea defined by the present disclosure.

1. A speech recognizing method in a multi-speaker environment performed by a computing system comprises:
analyzing a first conversation voice of a first speaker and a second speaker inputted through a microphone included in the computing system to determine a relation type between the first speaker and the second speaker;
receiving an input of a first conversation voice uttered by the first speaker or the second speaker, and determining a role of the speaker in the relation type through semantic analysis of the inputted conversation voice;
extracting a voice feature of the inputted first conversation voice, and determining the extracted voice feature as a voice feature of a speaker of the determined role;
receiving an input of a second conversation voice uttered by the first speaker or the second speaker, and determining a role in the relation type of the speaker of the second conversation voice by using voice feature extracted from the second conversation voice; and
determining a personalized service corresponding to the second conversation voice by using a role of the speaker of the second conversation voice in the relation type.

2. The speech recognizing method in a multi-speaker environment performed by a computing system of claim 1, further comprises:
displaying on a screen a script obtained as a result of STT (Speak-To-Text) processing of an utterance by the first speaker or the second speaker;
receiving optional input for a third conversation voice uttered by the second speaker included in the script; and
determining a role of the second speaker in the relation type according to the information input for the third conversation voice.

3. The speech recognizing method in a multi-speaker environment performed by a computing system of claim 2, further comprises:
identifying that an utterance of the first speaker or an utterance of the second speaker is not received for more than a threshold period of time;
inputting the script into a first artificial neural network and outputting, as voice, a text to speech (TTS) voice generated by the first artificial neural network, based on an output of the first artificial neural network.

4. The speech recognizing method in a multi-speaker environment performed by a computing system of claim 1, further comprises:
identifying a first speech command corresponding to an operation associated with the seat in the fourth conversation voice uttered by the first speaker or the second speaker; and
further performing an operation corresponding to the first speech command for a seat occupied by the speaker of the fourth conversation voice.

5. A speech recognizing method in a multi-speaker environment performed by a computing system comprises:
determining a relation type between the first speaker and the second speaker by analyzing a conversation voice of the first speaker and the second speaker inputted through a microphone included in the computing system;
determining a list of speech commands allowed for the second speaker by using the relation type; and
disregarding at least some of the speech commands uttered by the second speaker by using a list of speech commands allowed for the second speaker.

6. According to the speech recognizing method in a multi-speaker environment performed by a computing system of claim 5,
disregarding at least some of the speech commands uttered by the second speaker by using a list of speech commands allowed for the second speaker further comprises
displaying on a screen an alarm indicating that the second speaker has no permission for the second speech command if the second speech command uttered by the second speaker is disregarded.

7. According to the speech recognizing method in a multi-speaker environment performed by a computing system of claim 5,
identifying a third speech command corresponding to an operation associated with the seat from a fifth conversation voice uttered by the first speaker or the second speaker; and
performing an operation corresponding to the third speech command for a seat occupied by the speaker of the fifth conversation voice.

8. According to the speech recognizing method in a multi-speaker environment performed by a computing system of claim 5,
defining a list of speech commands which are allowed for each of the relation type between the first speaker and the second speaker based on user input.

9. According to the speech recognizing method in a multi-speaker environment performed by a computing system of claim 5,
receiving a sixth conversation voice uttered by the first speaker or the second speaker;
identifying that the sixth conversation voice corresponds to the fourth speech command, but identifying that the sixth conversation voice does not comprise a first parameter necessary to perform the operation corresponding to the fourth speech command;
outputting a TTS voice for querying the first parameter as a voice;
and
performing an operation corresponding to the fourth speech command by using the first parameter in response to receiving a seventh conversation voice from a speaker of the sixth conversation voice including the first parameter.

10. The speech recognizing method in a multi-speaker environment performed by a computing system of claim 9, further comprises:
converting the value of the first parameter based on the role of the speaker of the seventh conversation voice in the relation type.

11. A computing system, comprises:
one of more processors; and a memory which stores a computer program executed by one or more processors,
wherein the computer program is stored in a computer-readable recording medium to execute
analyzing a first conversation voice of a first speaker and a second speaker inputted through a microphone included in the computing system to determine a relation type between the first speaker and the second speaker;
receiving an input of a first conversation voice uttered by the first speaker or the second speaker, and determining a role of the speaker in the relation type through semantic analysis of the inputted conversation voice;
extracting a voice feature of the inputted first conversation voice, and determining the extracted voice feature as a voice feature of a speaker of the determined role;
receiving an input of a second conversation voice uttered by the first speaker or the second speaker, and determining a role in the relation type of the speaker of the second conversation voice by using voice feature extracted from the second conversation voice; and
determining a personalized service corresponding to the second conversation voice by using a role of the speaker of the second conversation voice in the relation type.

12. According to the speech recognizing method in a multi-speaker environment performed by a computing system of claim 11,
wherein the computer program is stored in a computer-readable recording medium to execute
displaying on a screen a script obtained as a result of STT (Speak-To-Text) processing of an utterance by the first speaker or the second speaker;
receiving optional input for a third conversation voice uttered by the second speaker included in the script; and
the computer program is stored on a computer-readable recording medium for further executing determining a role of the second speaker in a relation type based on the information inputted for the third conversation voice.

13. According to the speech recognizing method in a multi-speaker environment performed by a computing system of claim 12,
wherein the computer program is stored in a computer-readable recording medium to execute identifying that an utterance of the first speaker or an utterance of the second speaker is not received for more than a threshold period of time;
the computer program is stored on a computer-readable recording medium for further executing inputting the script to a first artificial neural network, and based on the output of the first artificial neural network, outputting a text to speech (TTS) voice generated by the first artificial neural network as a voice.

14. According to the speech recognizing method in a multi-speaker environment performed by a computing system of claim 12,
wherein the computer program is stored in a computer-readable recording medium to execute
identifying a first speech command corresponding to an operation associated with the seat in the fourth conversation voice uttered by the first speaker or the second speaker; and
stored on a computer-readable recording medium for further executing performing an operation corresponding to the first speech command for a seat occupied by the speaker of the fourth conversation voice.

15. A computing system, comprises:
one of more processors; and a memory which stores a computer program executed by one or more processors,
wherein the computer program is stored in a computer-readable recording medium to execute
determining a relation type between the first speaker and the second speaker by analyzing a conversation voice of the first speaker and the second speaker inputted through a microphone included in the computing system;
determining a list of speech commands allowed for the second speaker by using the relation type; and
stored on a computer-readable recording medium for executing disregarding at least a part of the speech commands uttered by the second speaker by using a list of speech commands allowable to the second speaker.

16. According to the speech recognizing method in a multi-speaker environment performed by a computing system of claim 15,
wherein the computer program is stored in a computer-readable recording medium to execute
disregarding at least some of the speech commands uttered by the second speaker by using a list of speech commands allowed for the second speaker further comprises
the computer program is stored on a computer-readable recording medium to execute displaying an alarm indicating that the second speaker has no permission for the second speech command if the second speech command uttered by the second speaker is disregarded.

17. According to the speech recognizing method in a multi-speaker environment performed by a computing system of claim 15,
wherein the computer program is stored in a computer-readable recording medium to execute
identifying a third speech command corresponding to an operation associated with the seat from a fifth conversation voice uttered by the first speaker or the second speaker; and
stored on a computer-readable recording medium for further executing performing an operation corresponding to the third speech command for a seat occupied by the speaker of the fifth conversation voice.

18. According to the speech recognizing method in a multi-speaker environment performed by a computing system of claim 15,
wherein the computer program is stored in a computer-readable recording medium to execute
stored on a computer-readable recording medium for further executing defining a list of speech commands allowed for each of the relation types between the first speaker and the second speaker based on user input.

19. According to the speech recognizing method in a multi-speaker environment performed by a computing system of claim 15,
wherein the computer program is stored in a computer-readable recording medium to execute
receiving a sixth conversation voice uttered by the first speaker or the second speaker;
identifying that the sixth conversation voice corresponds to the fourth speech command, but identifying that the sixth conversation voice does not comprise a first parameter necessary to perform the operation corresponding to the fourth speech command;
outputting a TTS voice for querying the first parameter as a voice;
and
stored on a computer-readable recording medium for further executing performing an operation corresponding to the fourth speech command by using the first parameter in response to receiving a seventh speech command from a speaker of the sixth conversation voice including the first parameter.

20. According to the speech recognizing method in a multi-speaker environment performed by a computing system of claim 19,
wherein the computer program is stored in a computer-readable recording medium to execute
the computer program is store on a computer-readable recording medium for further executing converting the value of the first parameter based on a role of the speaker of the seventh conversation voice in the relation type.
